(19) United States
(12) Patent Application Publication
(10) Pub. No.: US 2017/0071158 A1
(43) Pub. Date: Mar. 16, 2017

(54) PROTECTIVE DEVICE FOR AN INJURED ANIMAL

(71) Applicants: Peter M. Morykon, Fort Wayne, IN (US); Deborah L. Morykon, Fort Wayne, IN (US)

(72) Inventors: Peter M. Morykon, Fort Wayne, IN (US); Deborah L. Morykon, Fort Wayne, IN (US)

(21) Appl. No.: 14/850,277

(22) Filed: Sep. 10, 2015

(51) Int. Cl. A01K 13/00

(52) U.S. Cl. CPC A01K 13/007; A01K 13/006

(57) ABSTRACT

A protective device is configured to be used as a barrier to prevent access by an animal to an injury to its torso, limbs, or paws. The protective device is made to be worn directly at the location of the injury to the animal's torso, limbs, or paws. The protective device includes a flexible barrier and at least one spacer attached to the flexible barrier and arranged to hold the flexible barrier in place and spaced a distance away from the injury. At least one strap or connecting fastener is operable to conform and attach the protective device to the animal at the location of the injury.

### BACKGROUND OF THE INVENTION

1. Field of the Invention

The present invention relates to a protective device for an injured animal, and, more particularly, to a barrier that prevents the injured animal from biting, licking, or scratching at the injured area, while providing ventilation to allow the wound to heal properly.

2. Description of the Related Art

Dogs and other animals are well known to lick wounds and injured areas. This instinctive response may in certain instances have some beneficial effects. However, more often these animals will continue to lick, scratch, and bite at wounds and injured or irritated areas to an extent that prevents the wound or injured or irritated area from healing properly, or even to the point of causing further irritation or injury. In order to prevent this, it is also well known to use a pet cone, known as an “Elizabethan collar.” A pet cone of this type is generally a cone made of flexible plastic, with the small end of the cone attached around the animal's neck or affixed to its usual collar, and the large end of the cone oriented forward away from the animal's body and toward its muzzle.

Pet cones of this type are effective in presenting a barrier between the animal's mouth and an injury located on the animal's torso, limbs, or paws, thereby preventing the animal from licking or biting at the injury. They are also effective in presenting a barrier between the animal's paws and its head, thereby preventing the animal from scratching at its ears and eyes, in the case of an injury or irritation in that location. However, pet cones of this type suffer a number of significant drawbacks. They are cumbersome and disruptive to the animal, interfering with the animal's access with the rest of the uninjured parts of its body and thereby preventing the animal from engaging in normal self-grooming. Pet cones of this type make it difficult or impossible for the animal to eat or drink, and result in unsightly and unhygienic messes from food, water, and saliva contaminating the cone. They interfere with the movement of the animal, tending to catch on obstacles and knock items over. Being inherently cantilevered forward and loosely attached to the animal, they tend to move around from their optimal position, often coming into contact with the injury itself and inhibiting the process of healing. Additionally, pet cones of this type are unnecessarily distracting from the visual appeal of the animal. Finally, pet cones of this type tend to cause the animal to experience anxiety and emotional distress, which in some cases can cause or exacerbate behavior problems and potentially result in further injuries.

What is needed in the art is an effective barrier to prevent an animal from licking, biting, or scratching at a wound or injured or irritated area, in particular to the animal's torso, limbs, or paws, that is not unnecessarily cumbersome or disruptive to the animal. Such an effective barrier should not prevent access to uninjured areas, should allow the animal to eat and drink normally, should not unnecessarily interfere with the movement of the animal, and should not be overly distracting or distressing.

What is further needed in the art is such an effective barrier that also minimizes direct contact with the injured area, is flexible for movement, is adaptable to animals of various sizes, and may be used with or without underlying medical dressings or treatments.

### SUMMARY OF THE INVENTION

The present invention provides such an effective barrier to prevent an animal from licking, biting, or scratching at a wound or injured or irritated area. The present invention involves a protective device that presents a flexible barrier made of plastic or similar material worn at the site of the injury on the animal's torso, limbs, or paws. Foam rubber or similar material spacers hold the flexible barrier in place while holding it out away from the wound or irritated or injured area. Connecting fasteners, which may be Velcro, hooks and eyes, snaps, zippers, laces, adhesive, or tape, as non-limiting examples, may be used to conform the protective device in shape, such as in the shape of a cone, or in the case of a segmented embodiment to hold the segments together. Edges of the flexible barrier are provided with comfort edging, such as stitched or molded fabric or other material, in order to provide a non-irritating surface and to cover over any sharp edges of the flexible barrier material.

Ventilation holes allow air to circulate over the injured area for improved healing. As the spacers hold the flexible barrier between about one eighth and three quarters of an inch away from the injury, the present invention may be used with or without underlying medical dressings or treatments. In the case of an embodiment of the protective device conformed into the shape of a cone, further wide end spacing devices may be utilized to keep the cone approximately centered over the leg of the animal, while still providing the relative motion made possible by the cone shape.

In the case of an embodiment of the protective device in a planar arrangement, elastic straps with fasteners such as Velcro, hooks and eyes, buttons, or snaps, as non-limiting examples may be provided in order to hold the protective device in place. One or more rigid or semi-rigid support members may be provided to stiffen the protective device along an axis, while allowing greater flexibility in other directions. Foam rubber or similar material spacers again hold the flexible barrier in place while holding it out away from the wound or irritated or injured area.

In the case of an embodiment of the protective device in a segmented arrangement, a securing segment, which may be the upper segment, provides a secure attachment of the protective device to the leg of the animal near a joint or other area of high flexure. A connecting segment, which may be provided with a narrowed waist for improved flexibility, removably connects the securing segment to a covering segment, which may be the lower segment. Any of the segments may be variable in proportion, but especially the connecting segment, which may be of various lengths to accommodate various length joints.

The invention in one form is directed to a protective device for use as a barrier to prevent access by an animal to an injury to its torso, limbs, or paws. The protective device is configured to be worn directly at the location of the injury to the animal's torso, limbs, or paws. The protective device includes a flexible barrier and at least one spacer attached to the flexible barrier and arranged to hold the flexible barrier in place and spaced a distance away from the injury. At least one strap or connecting fastener is operable to conform and attach the protective device to the animal at the location of the injury.

The invention in another form is directed to a method of preventing access by an animal to an injury to its torso, limbs, or paws. The method includes several steps. The first step is providing a protective device in the form of a flexible barrier configured to be worn directly at the location of the injury to the animal's torso, limbs, or paws. The second step is providing at least one spacer attached to the flexible barrier and arranged to hold the flexible barrier in place and spaced a distance away from the injury. The third step is providing at least one strap or connecting fastener operable to conform and attach the protective device to the animal at the location of the injury.

An advantage of the present invention is that is not unnecessarily cumbersome or disruptive to the animal. Furthermore, it does not prevent access by the animal to uninjured areas, thereby allowing the animal to perform normal grooming of the uninjured areas. The present invention does not interfere with normal eating and drinking. It is not overly distracting or distressing to the animal, and does not tend to catch on obstacles. While minimizing direct contact with the injured area, the present invention is flexible for movement, adaptable to animals of various sizes, may be used with or without underlying medical dressings or treatments, and allows ventilation to the wounded area.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a bottom (inner) view of a protective device for an injured animal according to an embodiment of the invention, shown unrolled and laid flat;

FIG. 2 is an isometric view of a protective device for an injured animal according to the embodiment of the invention as shown in FIG. 1, shown rolled into the configuration in which it would be as worn by an animal;

FIG. 3 is a view of a protective device for an injured animal according to the embodiment of the invention as shown in FIGS. 1 and 2, shown being worn by an animal;

FIG. 4 is an isometric end view of a protective device for an injured animal according to another embodiment of the invention;

FIG. 5 is an isometric end view of a protective device for an injured animal according to another embodiment of the invention;

FIG. 6 is an isometric end view of a protective device for an injured animal according to another embodiment of the invention;

FIG. 7 is a top (outer) view of a protective device for an injured animal according to another embodiment of the invention;

FIG. 8 is a bottom (inner) view of a protective device for an injured animal according to the embodiment of the invention as shown in FIG. 7;

FIG. 9 is a bottom (inner) isometric view of a protective device for an injured animal according to the embodiment of the invention as shown in FIGS. 7 and 8;

FIG. 10 is a view of a protective device for an injured animal according to the embodiment of the invention as shown in FIGS. 7, 8, and 9, shown being worn by an animal;

FIG. 11 is a bottom (inner) view of the several parts of a segmented protective device for an injured animal according to another embodiment of the invention;

FIG. 12 is a top (outer) view of the several parts of the segmented protective device for an injured animal according to the embodiment of the invention as shown in FIG. 11;

FIG. 13 is a bottom (inner) isometric view of a segmented protective device for an injured animal according to the embodiment of the invention as shown in FIGS. 11 and 12, shown in FIG. 13 in a state of assembly; and

FIG. 14 is a view of a segmented protective device for an injured animal according to the embodiment of the invention as shown in FIGS. 11, 12, and 13, shown being worn by an animal.

Corresponding reference characters indicate corresponding parts throughout the several views. The exemplification set out herein illustrates embodiment of the invention, in one form, and such exemplification is not to be construed as limiting the scope of the invention in any manner.

### DETAILED DESCRIPTION OF THE INVENTION

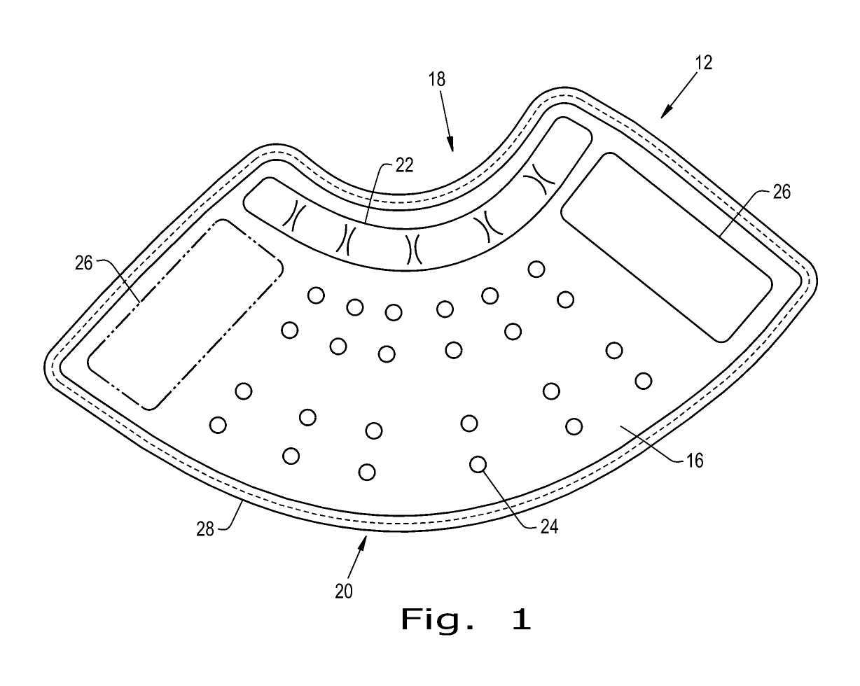

Referring now to FIGS. 1 through 3, there is shown a protective device 12 for an injured animal 10 according to an embodiment of the invention. In FIG. 1, the protective device 12 is shown from the bottom (inner) side, unrolled and laid flat. The protective device 12, which is intended to be rolled into a conically shaped barrier, is made of flexible barrier material 16, such as plastic, and is in the shape of an arc. A spacer 22 is provided at narrow end 18, which may be made of flexible foam rubber or an equivalent material. Connecting fasteners 26, in the embodiment shown being Velcro, are located at opposite ends and on opposite sides of the protective device 12. Although connecting fasteners 26 are shown as Velcro in the embodiment of the present invention shown in FIGS. 1 through 3, other types of connecting fasteners 26 are contemplated, such as hooks and eyes, snaps, zippers, laces, adhesive, or tape, as non-limiting examples. Comfort edging 28 is affixed to the edges of the protective device 12 to provide a non-irritating surface and to cover over any sharp edges of the flexible barrier material 16. Ventilation holes 24 are provided to allow air access to the injured area 50.

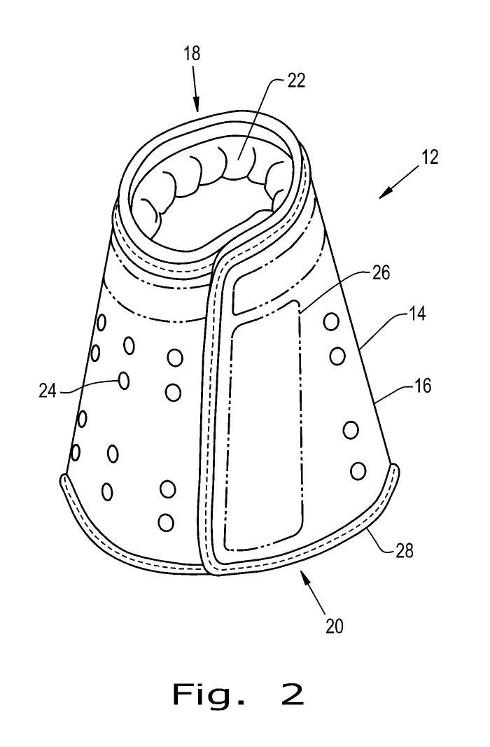

In FIG. 2, the protective device 12 is shown rolled into the configuration in which it would be as worn by an animal. The flexible barrier material 16 is connected at both ends by connecting fasteners 26 (shown in phantom lines through in this case semi-transparent flexible barrier material 16), thereby forming a conical barrier 14 having a narrow end 18 and a wide end 20. The spacer 22 now forms an approximate ring within the narrow end 18 of the conical barrier, thereby providing a snug fitting surface that engages an upper portion of the animal's leg, while holding the flexible barrier material 16 of the conical barrier 14 away from the injured area 50.

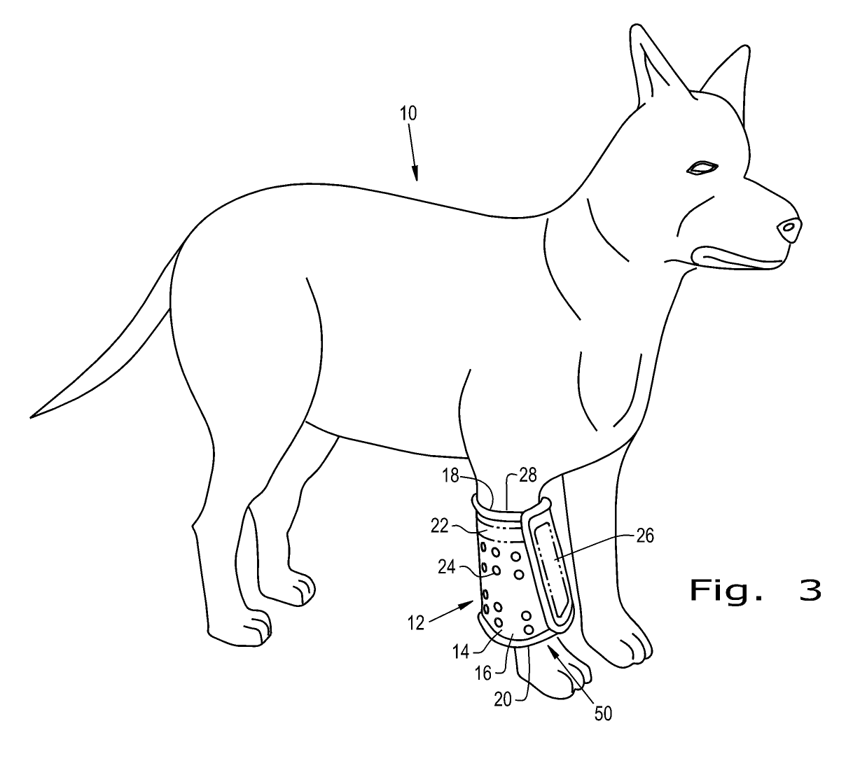

In FIG. 3, the protective device 12 is shown being worn by an animal 10 over an injured area 50. Again, the flexible barrier material 16 is connected at both ends by connecting fasteners 26, thereby forming a conical barrier 14 having a narrow end 18 and a wide end 20, with the spacer 22 within the narrow end 18, shown in phantom lines, engaging the upper portion of the animal's leg. Ventilation holes 24 allow air to access the injured area 50 for better healing. Comfort edging 28 again provides a non-irritating surface and covers any sharp edges of the flexible barrier material 16. Because the conical barrier 14 hangs from the spacer 22 downward over the animal's leg, it tends to remain in position. This prevent the animal 10 from licking, biting, or scratching the injured area 50, while allowing the animal 10 access to uninjured areas and not unnecessarily interfering with the animal.

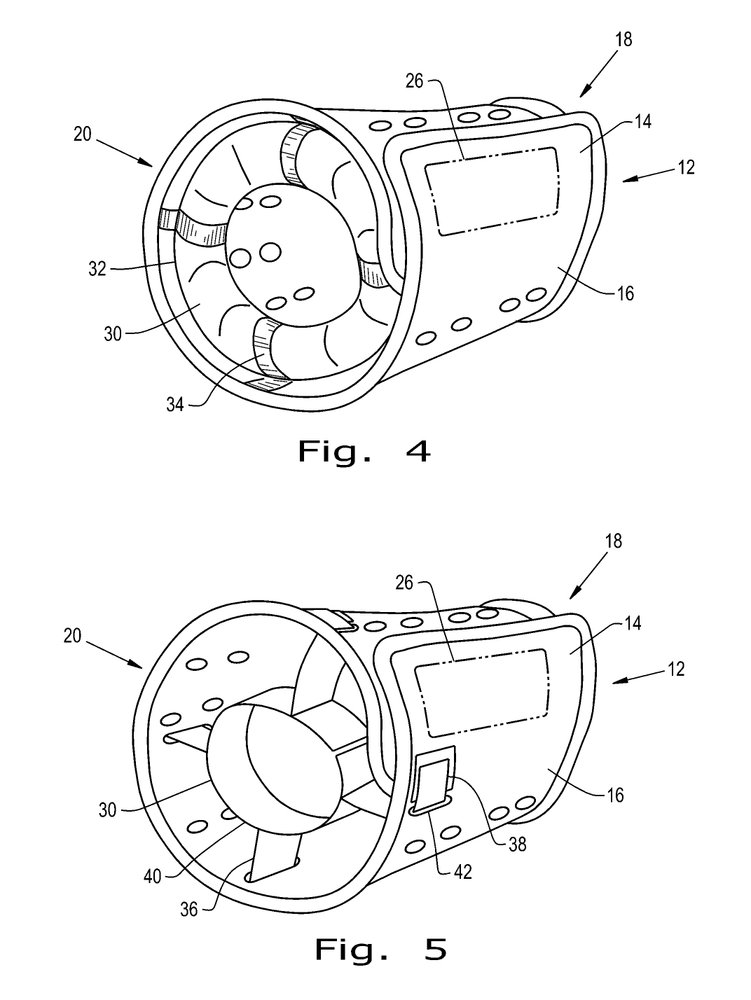

Although the conical barrier 14 of the protective device 12 tends to remain in position, further embodiments of the present invention provide additional ways to ensure that the conical barrier 14 securely remains in position and minimizes contact between the flexible barrier material 16 and the injured area 50. One such embodiment is provided in FIG. 4. Again, the protective device 12 made from flexible barrier material 16 rolled into a conical barrier 14 having a narrow end 18 and a wide end 20, and held by connecting fasteners 26. A wide end spacing device 30 takes the form of a doughnut 32, which may be formed of soft rubber, or may further be inflatable. Fasteners 34, in the embodiment shown being Velcro strips, may hold the doughnut 32 in the wide end 20 of the conical barrier 14. Alternately, in the embodiment wherein the doughnut 32 is inflatable, the doughnut may remain in place without the fasteners 34 by way of the compression against the flexible barrier material 16 and against the animal's leg. Although fasteners 34 are shown as Velcro in the embodiment of the present invention shown in FIG. 4, other types of fasteners 34 are contemplated, such as snaps, clips, adhesive, or tape, as non-limiting examples. In this way, the wide end 20 of the conical barrier 14 is held away from the leg of the animal while still allowing for relative motion.

Another such embodiment is provided in FIG. 5. Again, the protective device 12 made from flexible barrier material 16 rolled into a conical barrier 14 having a narrow end 18 and a wide end 20, and held by connecting fasteners 26. A wide end spacing device 30 takes the form of a ring 40, which may be a soft plastic, rubber, or foam snap-ring having a split or opening, so that it is deformed to go over the leg of the animal, and resumes its shape encompassing the leg. Alternately, the ring 40 may be an elastic, stretch fabric, rubber, foam rubber, or inflatable ring that is simply stretched over the leg of the animal. The ring 40 is held in an approximately centered location by elastic strips 36, which pass through slots 42 in the wide end 20 of the conical barrier 14, and then attach to the conical barrier 14 using fasteners 38. Although fasteners 38 are shown as Velcro in the embodiment of the present invention shown in FIG. 5, other types of fasteners 38 are contemplated, such as snaps, clips, adhesive, or tape, as non-limiting examples. In this way, the wide end 20 of the conical barrier 14 is held away from the leg of the animal while still allowing for relative motion.

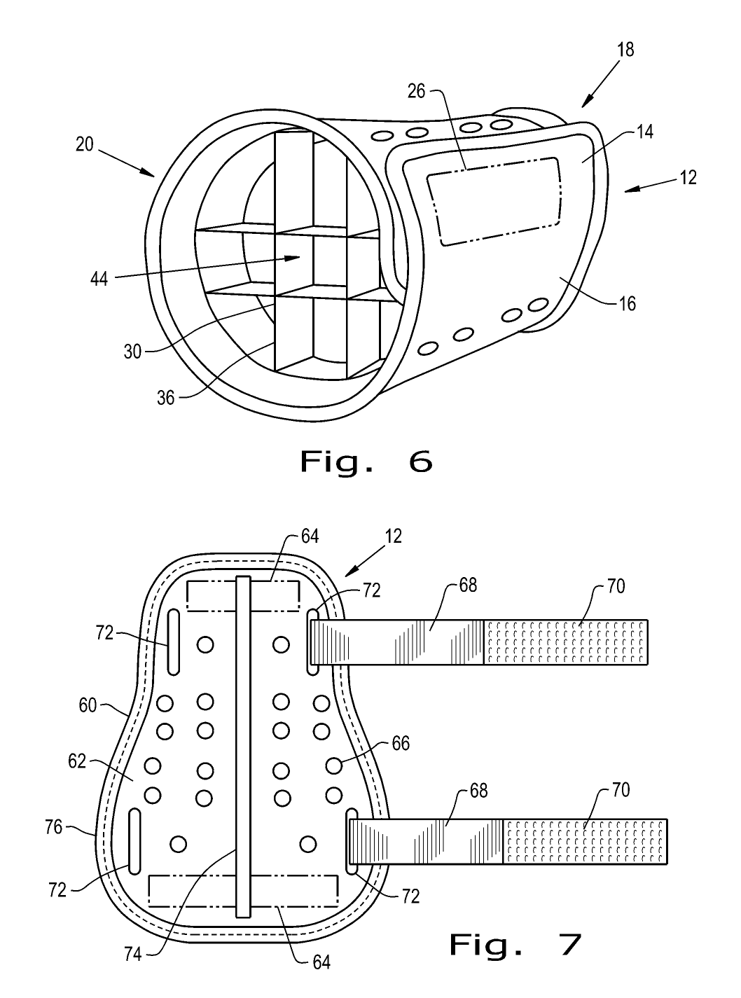

Another such embodiment is provided in FIG. 6. Again, the protective device 12 made from flexible barrier material 16 rolled into a conical barrier 14 having a narrow end 18 and a wide end 20, and held by connecting fasteners 26. In this case, the wide end spacing device 30 takes the form of just the elastic strips 36, which are arranged in an interconnected pattern such that the animal's leg is made to pass through a center opening 44, thereby holding the wide end 20 of the conical barrier 14 away from the leg of the animal while still allowing for relative motion. The elastic strips 36 may then be attached to the conical barrier 14 using Velcro, snaps, clips, adhesive, or tape, as non-limiting examples. Alternately, flexible plastic strips may be used in place of the elastic strips 36 in an interconnected pattern similar to the pattern shown, which would then be similarly attached to the conical barrier 14 using Velcro, snaps, clips, adhesive, or tape, as non-limiting examples.

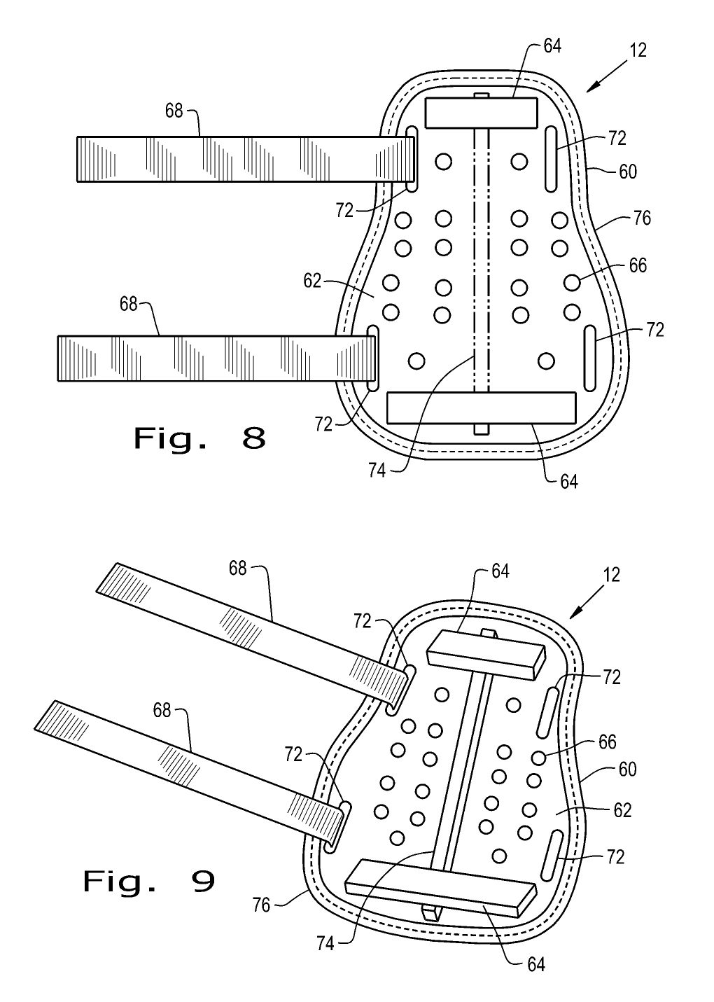

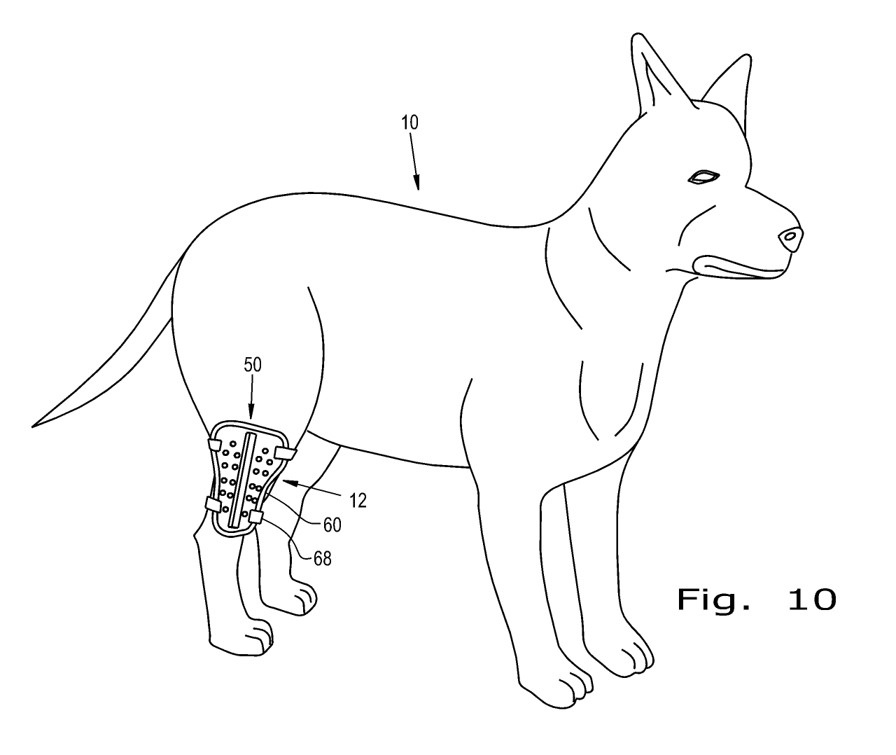

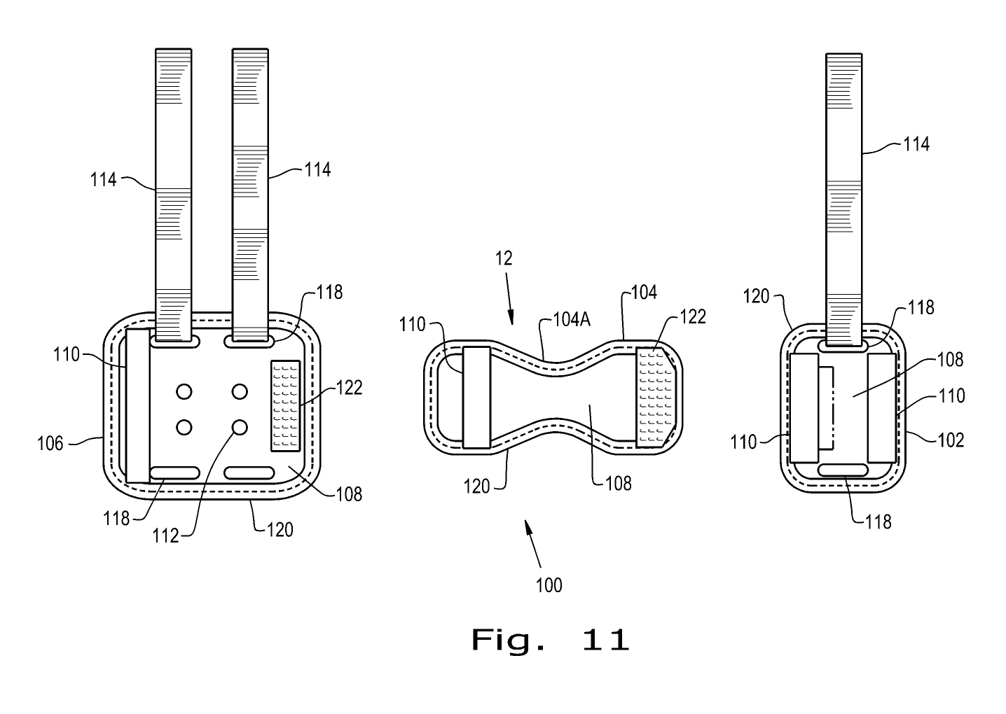

Referring now to FIGS. 7 through 10, there is shown a protective device 12 for an injured animal 10 according to another embodiment of the invention. In FIG. 7, the protective device 12 is shown from the top (outer) side. In FIG. 8, the protective device 12 is shown from the bottom (inner) side. In FIG. 9, the protective device 12 is shown in a bottom (inner) perspective view. In FIG. 10, the protective device 12 is shown being worn by an animal 10 over an injured area 50. The protective device 12 shown in FIGS. 7 through 10 is in the form of a pear or light bulb shaped planar barrier 60 made of flexible barrier material 62, such as plastic. Spacers 64 are provided on the inner side at the top and bottom of the planar barrier 60, and may be made of flexible foam rubber or an equivalent material. The spacers 64 function to hold the flexible barrier material 62 of the planar barrier 60 away from the injured area 50.

Elastic straps 68 are provided with strap connecting fasteners 70, in the embodiment shown being Velcro, although other types of strap connecting fasteners 70 are contemplated, such as hooks and eyes, buttons, or snaps, as non-limiting examples. The elastic straps 68 pass through strap holes 72 on one side of the planar barrier 60, and may be made to pass through strap holes 72 on the other side of the planar barrier 60 after wrapping around the leg of the injured animal 10. The elastic straps 68 then may be affixed by use of the strap connecting fasteners 70. A rigid or semi-rigid support member 74 extends between the top and bottom of the planar barrier 60 approximately along its center axis on the outer side, and is affixed to the surface of the planar barrier 60, in order to hold the planar barrier 60 away from the injured area 50 between the spacers 64. Comfort edging 76 is affixed to the edges of the protective device 12 to provide a non-irritating surface and to cover over any sharp edges of the planar barrier 60. Ventilation holes 66 are provided to allow air to access the injured area 50. The protective device 12 thereby prevents the animal 10 from licking, biting, or scratching the injured area 50, while allowing the animal 10 access to uninjured areas and not unnecessarily interfering with the animal.

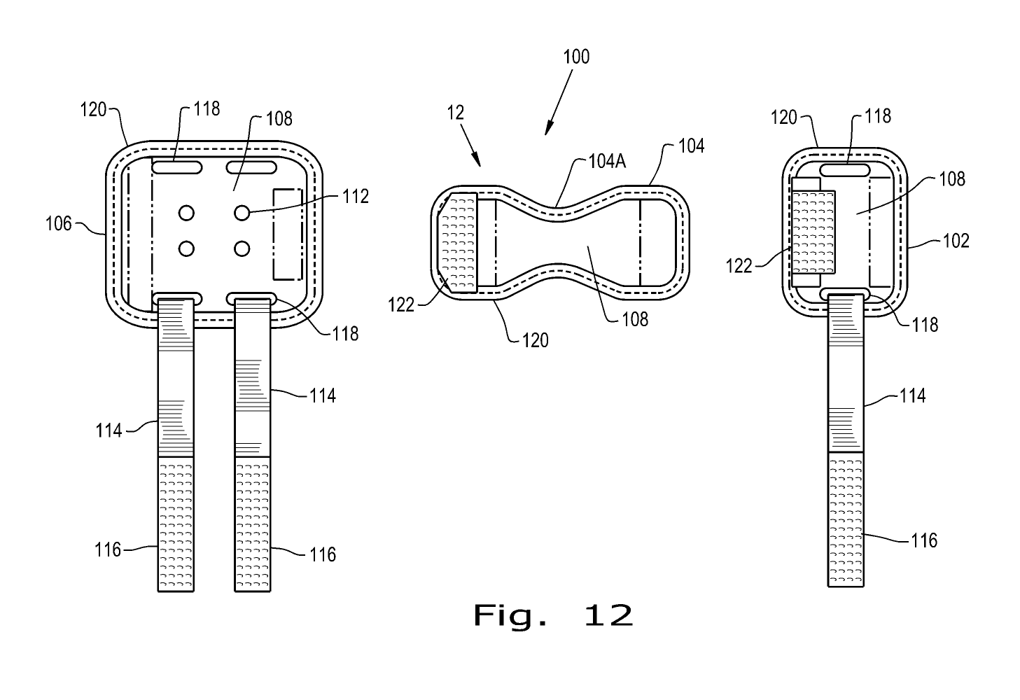

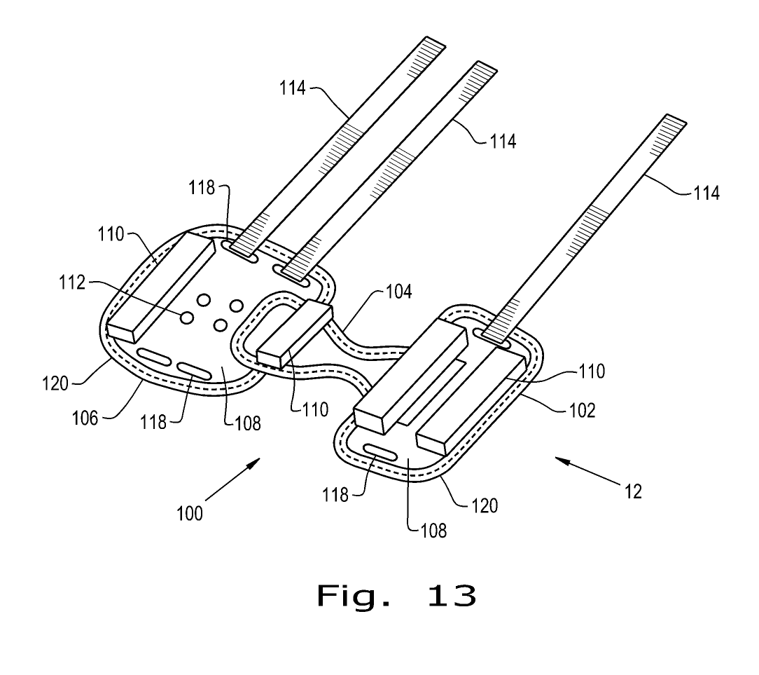

Referring now to FIGS. 11 through 14, there is shown a protective device 12 for an injured animal 10 according to another embodiment of the invention. In FIG. 11, the protective device 12, which takes the form of a segmented barrier 100, is shown from the bottom (inner) side and is shown with upper or securing segment 102, connecting segment 104, and lower or covering segment 106 in a state of separation. In FIG. 12, the protective device 12 in the form of a segmented barrier 100 is shown from the top (outer) side, again with upper or securing segment 102, connecting segment 104, and lower or covering segment 106 in a state of separation.

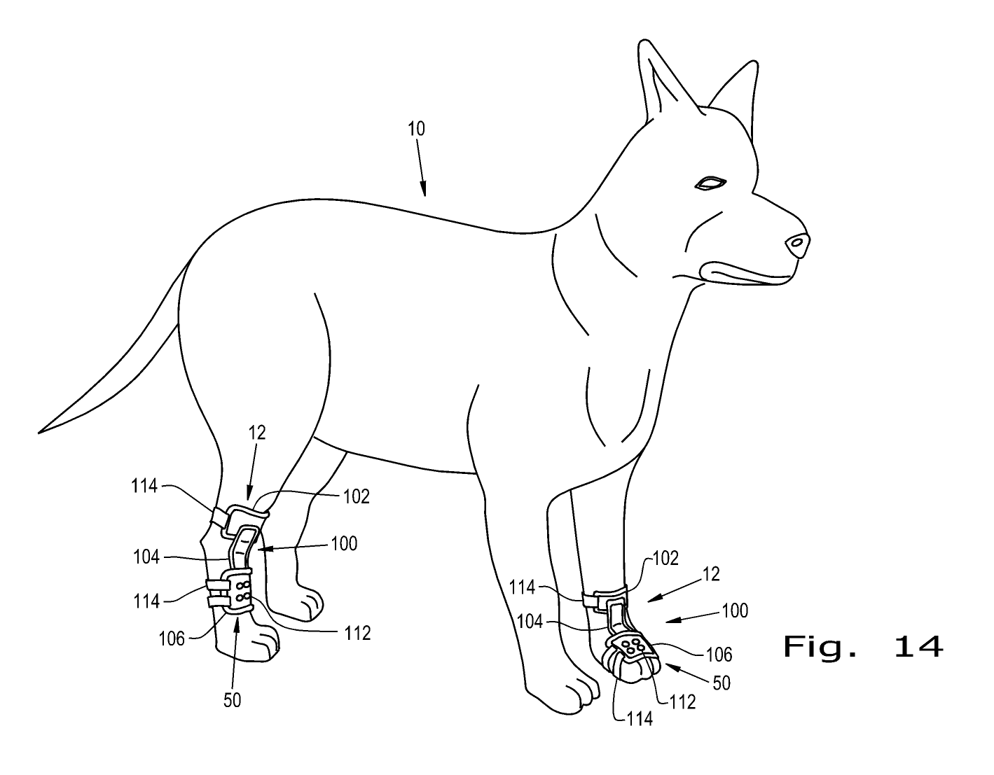

In FIG. 13, the protective device 12 in the form of a segmented barrier 100 is again shown from the bottom (inner) side, and is shown with upper or securing segment 102, connecting segment 104, and lower or covering segment 106 connected together as the protective device 12 may be configured when worn by an animal 10 over an injured area 50. In FIG. 14, protective devices 12 in the form of segmented barriers 100 are shown being worn by an animal 10 over injured areas 50, particularly injured areas near a bending joint such as at the hocks and paws. While the securing segment 102 is shown in each of the figures as the upper segment, and while the covering segment 106 is shown in each of the figures as the lower segment, it is contemplated that the segmented barrier 100 may be otherwise oriented in use.

Each of the upper or securing segment 102, connecting segment 104, and lower or covering segment 106 of the segmented barrier 100 is formed from flexible barrier material 108, such as plastic. The connecting segment 104 has a narrowed waist 104A for improved flexibility of the overall segmented barrier 100. Further, the connecting segment 104 may be provided in various lengths, to accommodate animals of various sizes. The upper or securing segment 102, connecting segment 104, and lower or covering segment 106 of the segmented barrier 100 are connected together using segment connecting fasteners 122, shown in the embodiments of FIGS. 11 through 14 as being Velcro. Although segment connecting fasteners 122 are shown as Velcro, other types of segment connecting fasteners 122 are contemplated, such as hooks and eyes, buttons, snaps, or clips, as non-limiting examples. Spacers 110 are provided on the inner sides of each of the upper or securing segment 102, connecting segment 104, and lower or covering segment 106, and may be made of flexible foam rubber or an equivalent material. The spacers 110 again function to hold the flexible barrier material 108 away from the injured area 50.

Elastic straps 114 are provided with strap connecting fasteners 116, in the embodiment shown being Velcro, although other types of strap connecting fasteners 116 are contemplated, such as hooks and eyes, buttons, or snaps, as non-limiting examples. The elastic straps 114 pass through strap holes 118 on one side of the upper or securing segment 102 or lower or covering segment 106 of the segmented barrier 100, and may be made to pass through strap holes 118 on the other side of the upper or securing segment 102 and lower or covering segment 106 of the segmented barrier 100 after wrapping around the leg of the injured animal 10. The elastic straps 114 then may be affixed by use of the strap connecting fasteners 116. Comfort edging 120 is affixed to the edges of the upper or securing segment 102, connecting segment 104, and lower or covering segment 106 to provide a non-irritating surface and to cover over any sharp edges of the segmented barrier 100. Ventilation holes 112 are provided to allow air to access the injured area 50. The protective device 12 thereby prevents the animal 10 from licking, biting, or scratching the injured area 50, while allowing the animal 10 access to uninjured areas and not unnecessarily interfering with the animal.

Each of the embodiments of the present invention shown in the above Figures may of course be made to various sizes and proportions in order to accommodate different sizes of animals. Also, although each of FIGS. 3, 10, and 14 show the animals being dogs, the present invention is contemplated as being usable with modification to suitable proportions with various animals such as cats, horse, or cows, as non-limiting examples.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A protective device for use as a barrier to prevent access by an animal to an injury to its torso, limbs, or paws, said protective device configured to be worn directly at the location of said injury to said torso, limbs, or paws, comprising:
a flexible barrier;
at least one spacer attached to said flexible barrier and arranged to hold said flexible barrier in place and spaced a distance away from said injury; and
at least one strap or connecting fastener operable to conform and attach said protective device to said animal at the location of said injury.

2. The protective device of claim 1, wherein:
said flexible barrier further being in the shape of an arc; and
said connecting fastener further comprising a first connecting fastener at one end of said arc and a second connecting fastener at the other end of said arc on the opposite side of said flexible barrier, said first and second connecting fasteners being usable to conform said flexible barrier into a conical barrier.

3. The protective device of claim 2, further comprising:
a wide end spacing device.

4. The protective device of claim 3, wherein:
said wide end spacing device is one of a doughnut, an inflatable doughnut, a ring held by elastic strips, and flexible strips in an interconnected pattern.

5. The protective device of claim 1, wherein:
said flexible barrier being a pear shaped planar barrier having rigid or semi-rigid support member attached to said flexible barrier along a first axis.

6. The protective device of claim 1, wherein:
said flexible barrier being a segmented barrier including a securing segment, a connecting segment, and a covering segment, said securing segment being removably connected to said connecting segment and said connecting segment being removably connected to said covering segment using segment connecting fasteners.

7. The protective device of claim 6, wherein:
said connecting segment being provided with a narrowed waist for flexibility.

8. The protective device of claim 1, wherein:
said flexible barrier being made of plastic.

9. The protective device of claim 1, wherein:
said at least one spacer being made of foam rubber.

10. The protective device of claim 1, wherein:
said at least one strap or connecting fastener using Velcro to conform and attach said protective device to said animal at the location of said injury.

11. The protective device of claim 1, wherein:
said flexible barrier being further provided with comfort edging.

12. The protective device of claim 1, wherein:
said flexible barrier being further provided with ventilation holes.

13. A method of preventing access by an animal to an injury to its torso, limbs, or paws, the method comprising the steps of:
providing a protective device in the form of a flexible barrier configured to be worn directly at the location of said injury to said torso, limbs, or paws;
providing at least one spacer attached to said flexible barrier and arranged to hold said flexible barrier in place and spaced a distance away from said injury; and
providing at least one strap or connecting fastener operable to conform and attach said protective device to said animal at the location of said injury.

14. The method of claim 13, wherein:
said flexible barrier further being in the shape of an arc; and
said connecting fastener further comprising a first connecting fastener at one end of said arc and a second connecting fastener at the other end of said arc on the opposite side of said flexible barrier, said first and second connecting fasteners being usable to conform said flexible barrier into a conical barrier.

15. The method of claim 14, further comprising the step of:
providing a wide end spacing device, said wide end spacing device being one of a doughnut, an inflatable doughnut, a ring held by elastic strips, and flexible strips in an interconnected pattern.

16. The method of claim 13, wherein:
said flexible barrier being a pear shaped planar barrier having rigid or semi-rigid support member attached to said flexible barrier along a first axis.

17. The method of claim 13, wherein:
said flexible barrier being a segmented barrier including a securing segment, a connecting segment, and a covering segment, said securing segment being removably connected to said connecting segment and said connecting segment being removably connected to said covering segment using segment connecting fasteners.

18. The method of claim 13, wherein:
said flexible barrier being made of plastic and being further provided with comfort edging; and
said at least one spacer being made of foam rubber.

19. The method of claim 13, further comprising the step of:
providing said flexible barrier with ventilation holes.

20. The method of claim 13, further comprising the step of:
placing said protective device over additional medical dressings or treatments.
